(19) United States
(12) Patent Application Publication
(10) Pub. No.: US 2023/0038882 A1
(43) Pub. Date: Feb. 9, 2023

(54) METHOD FOR CONTROLLING LOWER LIMIT OF STATE-OF-CHARGE OF POWER BATTERY, COMPUTER READABLE STORAGE MEDIUM, AND VEHICLE

(71) Applicant: GREAT WALL MOTOR COMPANY LIMITED, Baoding, Hebei (CN)

(72) Inventors: Qing ZHAO, Baoding, Hebei (CN); Shujiang CHEN, Baoding, Hebei (CN)

(21) Appl. No.: 17/790,154

(22) PCT Filed: Feb. 25, 2021
(86) PCT No.: PCT/CN2021/077829

§ 371 Date: Jun. 30, 2022

(30) Foreign Application Priority Data
Feb. 25, 2020 (CN) 202010115661.4

(51) Int. Cl. B60W 20/13; H01M 10/42; H01M 10/48; H02J 7/00

(52) U.S. Cl. CPC B60W 20/13; H01M 10/425; H01M 10/486; H02J 7/0047; H02J 7/0048; B60W 2555/20; B60W 2510/246; B60W 2510/244; B60W 2710/244; H01M 2220/20; H01M 2010/4271

(57) ABSTRACT

A method for controlling a lower limit of a state-of-charge state of a power battery, and a vehicle are provided, the method includes: detecting, by a detection unit, a minimum ambient temperature and a minimum power battery temperature in at least one time period; evaluating, by an evaluation unit, a minimum power battery temperature in a preset time period after the at least one time period according to the minimum ambient temperature and the minimum power battery temperature in the at least one time period; determining, by a processing unit, a minimum state-of-charge value that meets a start-up power requirement of a vehicle engine at the minimum power battery temperature in the preset time period, and adjusting a lower limit value of the state-of-charge according to the minimum state-of-charge value, in order that the vehicle can be powered-up by a state-of-charge value of the power battery at low temperature environment.

### CROSS-REFERENCE TO RELATED APPLICATIONS

This application claims priority to PCT Application No. PCT/CN2021/077829, having a filing date of Feb. 25, 2021, which claims priority to Chinese Application No. 202010115661.4, having a filing date of Feb. 25, 2020, the entire contents both of which are incorporated herein by reference.

### FIELD OF TECHNOLOGY

The following relates to the technical field of new energy vehicles, and more particularly to a method for controlling lower limit of state-of-charge of power battery, a power battery controller for controlling lower limit of state-of-charge of power battery, and a vehicle.

### BACKGROUND

Along with energy crisis and environmental pollution problems becoming apparent, hybrid vehicles have become an important development direction of automotive industry due to their prominent advantages in aspects of energy conservation and environmental protection. At present, a lower limit of a state of charge of power battery applied to the hybrid vehicles is fixed during use of the hybrid vehicles; when a power battery of a hybrid vehicle has a low state-of-charge value, after the vehicle is stopped and powered-off, the power battery has such a low state-of-charge value that it may not be able to enable the hybrid vehicle to be normally powered-up at a low temperature environment, so that an usage of normal functions of the hybrid vehicle is affected after the hybrid vehicle is powered-up next time.

### SUMMARY

An aspect relates to a method for controlling a lower limit of a state-of-charge of a power battery, a power battery controller for controlling the lower limit of the state-of-charge of the power battery, and a vehicle, thereby ensuring that the state-of-charge value of the power battery at the low temperature environment can enable the hybrid vehicle to be normally powered-up.

In order to achieve this objective, the technical solutions of the present disclosure are as follows:

a method for controlling a lower limit of a state-of-charge of a power battery, including: detecting a minimum ambient temperature and a minimum power battery temperature in at least one time period; evaluating a minimum power battery temperature in a preset time period after the at least one time period according to the minimum ambient temperature and the minimum power battery temperature in the at least one time period; determining a minimum state-of-charge value of the power battery that meets a start-up power requirement of a vehicle engine at the minimum power battery temperature in the preset time period; and adjusting a lower limit value of the state-of-charge of the power battery according to the minimum state-of-charge value of the power battery.

In one embodiment, the minimum ambient temperature and the minimum power battery temperature in the at least one time period only include a minimum ambient temperature and a minimum power battery temperature in a first time period, said evaluating the minimum power battery temperature in the preset time period after the at least one time period according to the minimum ambient temperature and the minimum power battery temperature in the at least one time period includes: determining the minimum power battery temperature in the preset time period according to the minimum power battery temperature, a temperature constant and a first power battery temperature evaluation factor in the first time period.

In one embodiment, the minimum ambient temperature and the minimum power battery temperature in the at least one time period include a minimum ambient temperature and a minimum power battery temperature in a first time period and a minimum ambient temperature and a minimum power battery temperature in a second time period, the second time period is subsequent to the first time period, said evaluating the minimum power battery temperature in the preset time period after the at least one time period according to the minimum ambient temperature and the minimum power battery temperature in the at least one time period includes: evaluating the minimum power battery temperature in the preset time period as the minimum power battery temperature in the first time period, when determining that the minimum ambient temperature in the first time period is lower than or equal to the minimum ambient temperature in the second time period, and the minimum power battery temperature in the first time period is lower than or equal to the minimum power battery temperature in the second time period; or evaluating the minimum power battery temperature in the preset time period as the minimum power battery temperature in the second time period, when determining that the minimum ambient temperature in the first time period is lower than or equal to the minimum ambient temperature in the second time period, and the minimum power battery temperature in the first time period is higher than the minimum power battery temperature in the second time period.

In one embodiment, the minimum ambient temperature and the minimum power battery temperature in the at least one time period include a minimum ambient temperature and a minimum power battery temperature in a first time period and a minimum ambient temperature and a minimum power battery temperature in a second time period, the second time period is subsequent to the first time period, said evaluating the minimum power battery temperature in the preset time period after the at least one time period according to the minimum ambient temperature and the minimum power battery temperature in the at least one time period includes: determining the minimum power battery temperature in the preset time period according to the minimum power battery temperature in the first time period, the minimum power battery temperature in the second time period and a second power battery temperature evaluation factor when determining that the minimum ambient temperature in the first time period is higher than the minimum ambient temperature in the second time period, and the minimum power battery temperature in the first time period is higher than the minimum power battery temperature in the second time period; or determining the minimum power battery temperature in the preset time period according to the minimum power battery temperature in the first time period, a temperature constant and a third power battery temperature evaluation factor, when determining that the minimum ambient temperature in the first time period is higher than the minimum ambient temperature in the second time period, and the minimum power battery temperature in the first time period is lower than or equal to the minimum power battery temperature in the second time period.

In one embodiment, said determining the minimum state-of-charge value of the power battery that meets the start-up power requirement of the vehicle engine at the minimum power battery temperature in the preset time period according to the minimum power battery temperature in the preset time period includes: substituting the minimum power battery temperature in the preset time period into a discharge power Map of the power battery to obtain the minimum state-of-charge value of the power battery.

As compared to the commonly used technical means in the conventional art, the method for controlling the lower limit of the state-of-charge of the power battery has the following advantages:

the method for controlling the lower limit of the state-of-charge of the power battery includes: detecting a minimum ambient temperature and a minimum power battery temperature in at least one time period; evaluating a minimum power battery temperature in a preset time period after the at least one time period according to the minimum ambient temperature and the minimum power battery temperature in the at least one time period; determining a minimum state-of-charge value that meets a start-up power requirement of a vehicle engine at the minimum power battery temperature in the preset time period according to the minimum power battery temperature in the preset time period; and adjusting a lower limit value of the state-of-charge according to the minimum state-of-charge value. Since the minimum power battery temperature in the future preset time of period has been evaluated, the lower limit value of the state-of-charge of the power battery is adjusted according to the minimum power battery temperature in the future preset time period, in order that the state-of-charge value of the power battery of the vehicle is equal to or greater than the lower limit value, so that it is ensured that the state-of-charge value at the low temperature environment can enable the vehicle to be normally powered-up.

Another objective of the present disclosure is to propose a power battery controller for controlling a lower limit of a state-of-charge of a power battery, thereby ensuring that the state-of-charge value of the power battery at the low temperature environment can enable the vehicle to be powered-up normally.

In order to achieve this objective, the technical solutions of the present disclosure are as follows:

a power battery controller for controlling a lower limit of a state-of-charge of a power battery, including a detector, an evaluator and a processor, where the detector is configured to detect a minimum ambient temperature and a minimum power battery temperature in at least one time period; the evaluator is configured to evaluate a minimum power battery temperature in a preset time period after the at least one time period according to the minimum ambient temperature and the minimum power battery temperature in the at least one time period; the processor is configured to determine a minimum state-of-charge value of the power battery that meets a start-up power requirement of a vehicle engine at the minimum power battery temperature in the preset time period according to the minimum power battery temperature in the preset time period, and adjust a lower limit value of the state-of-charge of the power battery according to the minimum state-of-charge value of the power battery.

In one embodiment, the minimum ambient temperature and the minimum power battery temperature in the at least one time period only include a minimum ambient temperature and a minimum power battery temperature in a first time period, and the evaluator is further configured to determine the minimum power battery temperature in the preset time period according to the minimum power battery temperature, a temperature constant and a first power battery temperature evaluation factor in the first time period.

In one embodiment, the minimum ambient temperature and the minimum power battery temperature in the at least one time period include a minimum ambient temperature and a minimum power battery temperature in a first time period and a minimum ambient temperature and a minimum power battery temperature in a second time period, the second time period is subsequent to the first time period, and the evaluator is further configured to: evaluate the minimum power battery temperature in the preset time period as the minimum power battery temperature in the first time period when determining that the minimum ambient temperature in the first time period is lower than or equal to the minimum ambient temperature in the second time period, and the minimum power battery temperature in the first time period is lower than or equal to the minimum power battery temperature in the second time period; or evaluate the minimum power battery temperature in the preset time period as the minimum power battery temperature in the second time period when determining that the minimum ambient temperature in the first time period is lower than or equal to the minimum ambient temperature in the second time period, and the minimum power battery temperature in the first time period is higher than the minimum power battery temperature in the second time period.

In one embodiment, the minimum ambient temperature and the minimum power battery temperature in the at least one time period include a minimum ambient temperature and a minimum power battery temperature in a first time period and a minimum ambient temperature and a minimum power battery temperature in a second time period, the second time period is subsequent to the first time period, and the evaluator is further configured to: determine the minimum power battery temperature in the preset time period according to the minimum power battery temperature in the first time period, the minimum power battery temperature in the second time period and a second power battery temperature evaluation factor when determining that the minimum ambient temperature in the first time period is higher than the minimum ambient temperature in the second time period, and the minimum power battery temperature in the first time period is higher than the minimum power battery temperature in the second time period; or determine the minimum power battery temperature in the preset time period according to the minimum power battery temperature in the first time period, a temperature constant and a third power battery temperature evaluation factor when determining that the minimum ambient temperature in the first time period is higher than the minimum ambient temperature in the second time period, and the minimum power battery temperature in the first time period is lower than or equal to the minimum power battery temperature in the second time period.

The power battery controller for controlling the lower limit of the state-of-charge of the power battery and the method for controlling the lower limit of the state-of-charge of the power battery have the same advantages over the conventional art, so that the advantages of the power battery controller for controlling the lower limit of the state-of-charge of the power battery are not repeatedly described here.

Another objective of the present disclosure is to propose a vehicle to ensure that the state-of-charge value of the power battery at the low temperature environment can enable the vehicle to be powered-up normally.

In order to achieve this objective, the technical solutions of the present disclosure are as follows:

A vehicle, including the power battery controller for controlling the lower limit of the state-of-charge of the power battery as described above.

The vehicle and the power battery controller for controlling the lower limit of the state-of-charge of the power battery have the same advantages over the conventional art, so that the advantages of the vehicle are not repeatedly described here.

Another objective of the present disclosure is to propose a computer readable storage medium to ensure that the state-of-charge value of the power battery at the low temperature environment can enable the vehicle to be powered-up normally.

In order to achieve this objective, the technical solutions of the present disclosure are as follows:

A non-transitory computer readable storage medium which stores an instruction that is executed to cause the power battery controller of the vehicle to perform the aforesaid method for controlling the lower limit of the state-of-charge of the power battery.

The computer readable storage medium and the method for controlling the lower limit of the state-of-charge of the power battery have the same advantages over the conventional art, so that the advantages of the computer readable storage medium are not repeatedly described here.

Other features and benefits of the present disclosure will be described in detail in the subsequent detailed description of embodiments.

### BRIEF DESCRIPTION

Some of the embodiments will be described in detail, with reference to the following figures, wherein like designations denote like members, wherein:

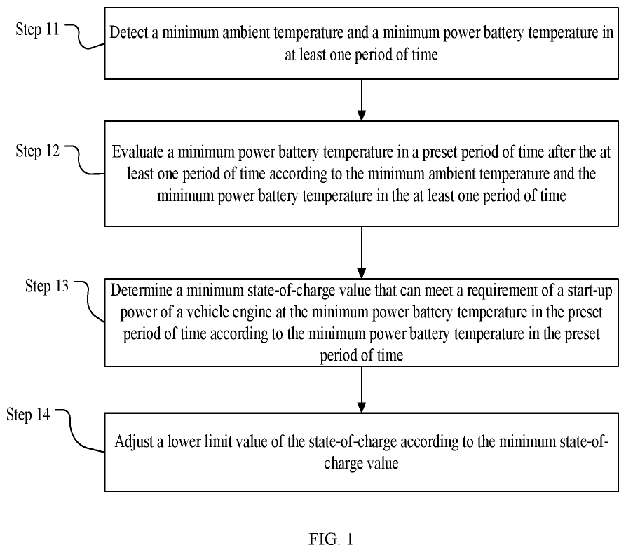

FIG. 1 is a flowchart of a method for controlling a lower limit of a state-of-charge of a power battery according to one embodiment of the present disclosure;

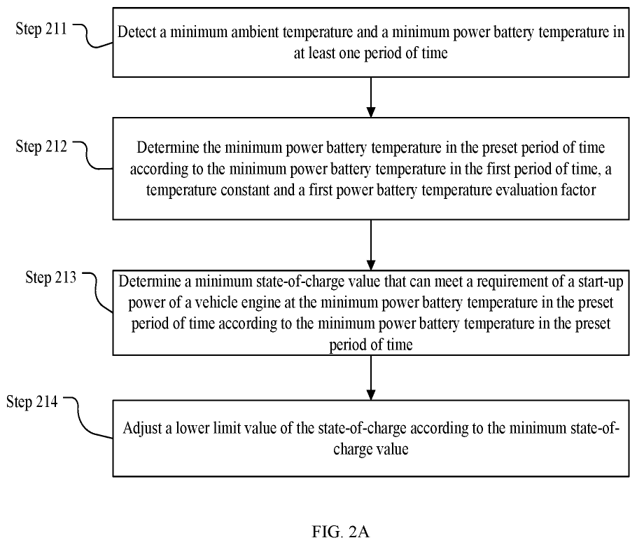

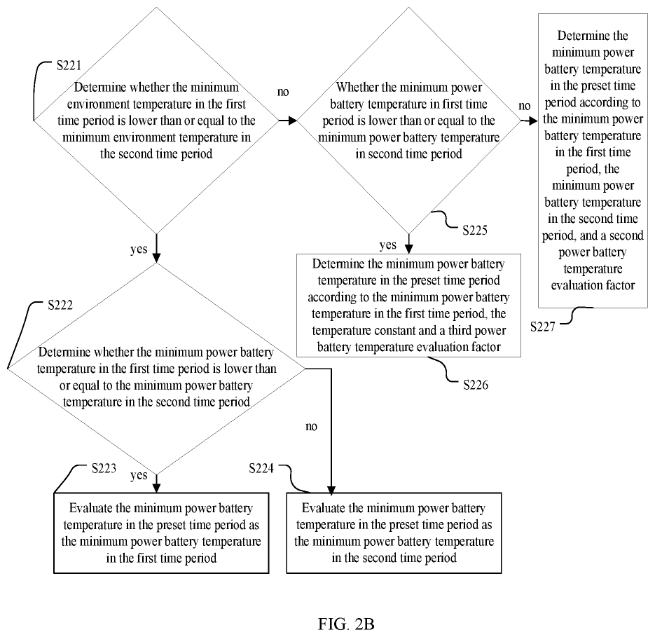

FIG. 2A is a flowchart of the method for controlling the lower limit of the state-of-charge of the power battery according to another embodiment of the present disclosure;

FIG. 2B is a flowchart of the method for controlling the lower limit of the state-of-charge of the power battery according to another embodiment of the present disclosure; and

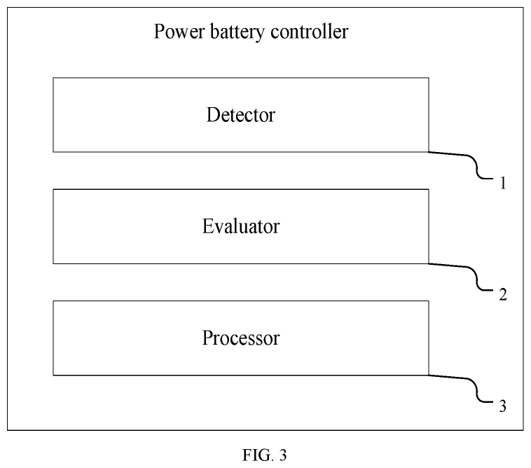

FIG. 3 illustrates a schematic block diagram of a power battery controller for controlling a lower limit of a state-of-charge of a power battery according to one embodiment of the present disclosure.

Reference signs are described below:
1—detector; 2—evaluator
3—processor

### DETAILED DESCRIPTION

It should be noted that, in the case of no conflict, the embodiments of the present disclosure and the features in the embodiments may be combined with each other.

The present disclosure will be described in detail below with reference to the accompanying drawings and in combination with the embodiments.

FIG. 1 is a flowchart of a method for controlling a state-of-charge of a power battery according to one embodiment of the present disclosure. As shown in FIG. 1, this method includes:

At step S11, a minimum ambient temperature and a minimum power battery temperature in at least one time period are detected.

In particular, a temperature sensor may be used to detect an ambient temperature and a power battery temperature, then, the ambient temperature and the power battery temperature are stored, then, the minimum ambient temperature and the minimum power battery temperature are determined. The at least one time period may be, for example, a time period such as 5 days, 10 days or 30 days, as an alternative, the at least one time period may be two time periods (two separate 5 days). If the at least one time period refers to two separate time periods, the minimum ambient temperature and the minimum power battery temperature in each of the two separate time periods are obtained respectively.

It is obvious that, since the present disclosure is directed to vehicles, it is also possible to use various functional devices equipped on a vehicle to detect the minimum ambient temperature and the minimum power battery temperature. For example, in particular:

BMS (Battery Management System) can detect the temperature of the power battery after regular self-wake-up (which may be performed by multiple times), a CAN (Controller Area Network) of the vehicle is waken up when the temperature of the power battery is below a temperature threshold (e.g., 0° C.), then, the BMS waits for sleep. Then, an air conditioner controller is awakened to send the current ambient temperature to a HCU (Hybrid Control Unit), and then waits for sleep. A HUT (Head Unit System) is awakened to send the current date and time to the HCU, and then waits for sleep. After the HCU is awakened, the HCU is configured to: receive the temperature of the power battery and the ambient temperature; write the received temperature of the power battery and the ambient temperature into a daily record of power battery temperature and ambient temperature; and determine the minimum power battery temperature and the minimum ambient temperature in this day based on the effective record (the effective record is not equal to a default value 100, the temperature is invalid if a failure of temperature detection of the BMS or the air conditioner controller occurs) of power battery temperature and the ambient temperature record in this day; and record the minimum power battery temperature and the ambient temperature in this day, and thereby obtains the minimum power battery temperature and the minimum ambient temperature in any time period according to the daily record of the minimum power battery temperature and the ambient temperature. If the daily record of the minimum power battery temperature and the daily record of the minimum ambient temperature are invalid in one certain time period (i.e., the default value 100), it means that the minimum power battery temperature or the minimum ambient temperature in this time period is also invalid (i.e., the default value 100).

At step S12, a minimum power battery temperature in a preset time period after the at least one time period is evaluated according to the minimum ambient temperature and the minimum power battery temperature in the at least one time period.

In particular, as shown in FIG. 2A, if the at least one time period is only one time period (e.g., the first time period), or the at least one time period refers to two time periods, however, the minimum ambient temperature or the minimum power battery temperature in one of the two time periods is invalid (i.e., the default value is 100), in this case, the step S212 is performed to replace the step S12, and the minimum power battery temperature in the preset time period is determined according to the minimum power battery temperature in the first time period, the temperature constant and the first power battery temperature evaluation factor.

A formula is expressed as: T0=T1+C×q1, where T0 is the minimum power battery temperature in the preset time period, T1 is the minimum power battery temperature in the first time period, C is the temperature constant, and q1 is the first power battery temperature evaluation factor. The temperature constant is, for example, 5° C., this constant value may be calibrated according to actual requirement. The first power battery temperature evaluation factor q1 may be obtained by being substituted into the formula T0=T1+C×q1 relating to the minimum power battery temperature T1 and the minimum ambient temperature in the first time period, and by querying a “correspondence table between the power battery temperature evaluation factor and the minimum power battery temperature and the minimum ambient temperature”. A range of the first power battery temperature evaluation factor q1 is between 0 and 2. The correspondence table between the power battery temperature evaluation factor and the minimum power battery temperature and the minimum ambient temperature may be obtained by calibrating previously; for example, if the minimum ambient temperature and the minimum power battery temperature of the past 10 days are used to evaluate the minimum ambient temperature and the minimum power battery temperature in the future 10 days after the past 10 days (i.e., the preset time period described above), then, the minimum ambient temperature and the minimum power battery temperature in the past 10 days are detected after the temperature constant C is set, then, the minimum ambient temperature and the minimum power battery temperature in the future 10 days after the past 10 days are detected, then, the detection values are substituted into the formula T0=T1+C×q1 to obtain the first power battery temperature evaluation factor q1. The aforesaid process is repeatedly executed for many times, so that the first power battery temperature evaluation factor q1 corresponding to the various minimum ambient temperatures and the minimum power battery temperatures in many past 10 days may be obtained according to a large amount of actual data; this calibration method is commonly used, and the details of this calibration method are not repeatedly described here.

As shown in FIG. 2B, if the at least one time period refers to two time periods, that is, the first time period and the second time period (i.e., the second time period is subsequent to the first time period), and the minimum ambient temperatures and the minimum power battery temperatures in the two time periods are valid, the following steps S221-S227 are performed to replace the step S12.

At step S221, whether the minimum ambient temperature in the first time period is lower than or equal to the minimum ambient temperature in the second time period is determined;

At step S222, whether the minimum power battery temperature in the first time period is lower than or equal to the minimum power battery temperature in the second time period is determined when the minimum ambient temperature in the first time period is lower than or equal to the minimum ambient temperature in the second time period;

At step S223, the minimum power battery temperature in the preset time period is evaluated as the minimum power battery temperature in the first time period, when the minimum power battery temperature in the first time period is lower than or equal to the minimum power battery temperature in the second time period;

At step S224, the minimum power battery temperature in the preset time period is evaluated as the minimum power battery temperature in the second time period, when the minimum power battery temperature in the first time period is higher than the minimum power battery temperature in the second time period.

At step S225, whether the minimum power battery temperature in the first time period is lower than or equal to the minimum power battery temperature in the second time period is determined, when the minimum ambient temperature in the first time period is higher than the minimum ambient temperature in the second time period;

At step S226, the minimum power battery temperature in the preset time period is determined according to the minimum power battery temperature, the temperature constant and the third power battery temperature evaluation factor in the first time period, when the minimum power battery temperature in the first time period is lower than or equal to the minimum power battery temperature in the second time period.

At step S226, the calculation formula for the minimum power battery temperature in the preset time period is expressed as:

T0=T1+C×q3, where T0 is the minimum power battery temperature in the preset time period, T1 is the minimum power battery temperature in the first time period, C is the temperature constant, and q3 is the third power battery temperature evaluation factor. The third power battery temperature evaluation factor q3 may likewise be obtained by being substituted into the formula relating the minimum power battery temperature T1 and the minimum ambient temperature in the first time period, and by querying the “correspondence table between the power battery temperature evaluation factor and the minimum power battery temperature and the minimum ambient temperature”. A range of the third power battery temperature evaluation factor q3 is between 0 and 2.

In step S227, the minimum power battery temperature in the preset time period is determined according to the minimum power battery temperature in the first time period, the minimum power battery temperature in the second time period and the second power battery temperature evaluation factor, when the minimum power battery temperature in the first time period is higher than the minimum power battery temperature in the second time period.

At step S227, the calculation formula for the minimum power battery temperature in the preset time period is expressed as:

T0=T2+(T2−T1)×q2, where T0 is the minimum power battery temperature in the preset time period, T1 is the minimum power battery temperature in the first time period, T2 is the minimum power battery temperature in the second time period, and q2 is the second power battery temperature evaluation factor. The second power battery temperature evaluation factor q2 may likewise be obtained by being substituted into a difference between the minimum ambient temperature T2 in the second time period and the minimum ambient temperature T1 in the first time period and a difference between the minimum power battery temperature in the second time period and the minimum power battery temperature in the first time period, and by querying the corresponding table between the second power battery temperature evaluation factor q2 and the minimum power battery temperature and the minimum ambient temperature. A range of the second power battery temperature evaluation factor q2 is between 0 and 2.

At step S13, determining a minimum state-of-charge value that meets a start-up power requirement of a vehicle engine at the minimum power battery temperature in the preset time period according to the minimum power battery temperature in the preset time period;

In particular, the minimum power battery temperature in the preset time period is substituted into a discharge power Map of the power battery to obtain the minimum state-of-charge value of the power battery. The discharge power Map of the power battery is known, but is different for different vehicles or power batteries.

At step S14, a lower limit value of the state-of-charge of the power battery is adjusted according to the minimum state-of-charge value.

In particular, a reserved quantity is added to the minimum state-of-charge value to serve as the lower limit value of the evaluated state-of-charge for ensuring low-temperature cold start of the engine. The one having greater value in the evaluated lower limit value of the state-of-charge for ensuring the low-temperature cold start of the engine and a lower limit value of a state-of-charge of a battery pack defined by a battery supplier is selected, and is taken as the final lower limit value of the state-of-charge. If the evaluated temperature in the future 10 days is reduced, the state-of-charge value of the power battery needs to be adjusted to be 25% or above 25% in order to start up the vehicle, so that the lower limit value of the state-of-charge is adjusted to be 25% from a fixed value of 15%, and the state-of-charge value being no less than 25% is maintained; for example, the vehicle is stopped and cannot be used when the state-of-charge value is about to be dropped below 25%; as an alternative, the state-of-charge value is kept above 25% by charging when the state-of-charge value of the power battery is dropped below 25%, so that a problem that a battery discharge power does not meet the start-up power requirement of the vehicle engine after the vehicle is stopped and powered-off due to the drop of power battery pack temperature, which is further caused due to the drop of ambient temperature in the future 10 days, so that the engine cannot be started, and the vehicle cannot be used is solved.

FIG. 3 is a structural block diagram of a power battery controller for controlling a lower limit of a state-of-charge of a power battery according to one embodiment of the present disclosure. As shown in FIG. 3, the power battery controller includes: a detector 1, an evaluator 2, and a processor 3, where the detector 1 is configured to detect a minimum ambient temperature and a minimum power battery temperature in at least one time period; the evaluator 2 is configured to evaluate a minimum power battery temperature in a preset time period after the at least one time period according to the minimum ambient temperature and the minimum power battery temperature in the at least one time period; the processor 3 is configured to determine a minimum state-of-charge value of the power battery that can meet a start-up power requirement of a vehicle engine at a minimum power battery temperature in the preset time period, and adjust a lower limit value of the state-of-charge of the power battery according to the minimum state-of-charge value of the power battery.

In one preferable embodiment, the minimum ambient temperature and the minimum power battery temperature in the at least one time period only include a minimum ambient temperature and a minimum power battery temperature in a first time period, the evaluator 2 is further configured to: determine the minimum power battery temperature in the preset time period according to the minimum power battery temperature, a temperature constant and a first power battery temperature evaluation factor in the first time period.

In one preferable embodiment, the minimum ambient temperature and the minimum power battery temperature in the at least one time period include a minimum ambient temperature and a minimum power battery temperature in a first time period and a minimum ambient temperature and a minimum power battery temperature in a second time period, the second time period is subsequent to the first time period, the evaluator 2 is further configured to: evaluate the minimum power battery temperature in the preset time period as the minimum power battery temperature in the first time period when determining that the minimum ambient temperature in the first time period is lower than or equal to the minimum ambient temperature in the second time period, and the minimum power battery temperature in the first time period is lower than or equal to the minimum power battery temperature in the second time period; or evaluate the minimum power battery temperature in the preset time period as the minimum power battery temperature in the second time period when determining that the minimum ambient temperature in the first time period is lower than or equal to the minimum ambient temperature in the second time period, and the minimum power battery temperature in the first time period is higher than the minimum power battery temperature in the second time period.

In one preferable embodiment, the minimum ambient temperature and the minimum power battery temperature in the at least one time period include a minimum ambient temperature and a minimum power battery temperature in a first time period and a minimum ambient temperature and a minimum power battery temperature in a second time period, the second time period is subsequent to the first time period, the evaluator 2 is further configured to: determine the minimum power battery temperature in the preset time period according to the minimum power battery temperature in the first time period, the minimum power battery temperature in the second time period and a second power battery temperature evaluation factor when determining that the minimum ambient temperature in the first time period is higher than the minimum ambient temperature in the second time period, and the minimum power battery temperature in the first time period is higher than the minimum power battery temperature in the second time period; or determine the minimum power battery temperature in the preset time period according to the minimum power battery temperature in the first time period, a temperature constant and a third power battery temperature evaluation factor when determining that the minimum ambient temperature in the first time period is higher than the minimum ambient temperature in the second time period, and the minimum power battery temperature in the first time period is lower than or equal to the minimum power battery temperature in the second time period.

In one preferable embodiment, the processor 3 is configured to substitute the minimum power battery temperature in the preset time period into a discharge power Map of the power battery to obtain the minimum state-of-charge value of the power battery.

The embodiment of the power battery controller for controlling the lower limit of the state-of-charge of the power battery has basically the same technical contents with the embodiment of the method for controlling the lower limit of the state-of-charge of the power battery, so that the embodiment of the power battery controller for controlling the lower limit of the state-of-charge of the power battery is not repeatedly described here.

A vehicle is further provided in the present disclosure, this vehicle includes the aforesaid power battery controller for controlling the lower limit of the state-of-charge of the power battery.

A computer readable storage medium is further provided in the present disclosure, the computer readable storage medium stores an instruction which causes the power battery controller of the vehicle to perform the aforesaid method for controlling the lower limit of the state-of-charge of the power battery.

The embodiment of the vehicle and the embodiment of the computer readable storage medium have basically the same technical contents with the embodiment of the method for controlling the lower limit of the state-of-charge of the power battery, so that the embodiment of the vehicle and the embodiment of the computer readable storage medium are not repeatedly described here.

Although the invention has been illustrated and described in greater detail with reference to the preferred exemplary embodiment, the invention is not limited to the examples disclosed, and further variations can be inferred by a person skilled in the art, without departing from the scope of protection of the invention.

For the sake of clarity, it is to be understood that the use of “a” or “an” throughout this application does not exclude a plurality, and “comprising” does not exclude other steps or elements.

1. A method for controlling a lower limit of a state-of-charge of a power battery, the method comprising:
detecting a minimum ambient temperature and a minimum power battery temperature in at least one time period;
evaluating a minimum power battery temperature in a preset time period after the at least one time period according to the minimum ambient temperature and the minimum power battery temperature in the at least one time period;
determining a minimum state-of-charge value of the power battery that meets a start-up power requirement of a vehicle engine at the minimum power battery temperature in the preset time period; and
adjusting a lower limit value of the state-of-charge of the power battery according to the minimum state-of-charge value of the power battery.

2. The method-according to claim 1, wherein the minimum ambient temperature and the minimum power battery temperature in the at least one time period only comprise a minimum ambient temperature and a minimum power battery temperature in a first time period, evaluating the minimum power battery temperature in the preset time period after the at least one time period according to the minimum ambient temperature and the minimum power battery temperature in the at least one time period comprises:
determining the minimum power battery temperature in the preset time period according to the minimum power battery temperature, a temperature constant and a first power battery temperature evaluation factor in the first time period.

3. The method according to claim 1, wherein the minimum ambient temperature and the minimum power battery temperature in the at least one time period comprise a minimum ambient temperature and a minimum power battery temperature in a first time period and a minimum ambient temperature and a minimum power battery temperature in a second time period, the second time period is subsequent to the first time period, the evaluating the minimum power battery temperature in the preset time period after the at least one time period according to the minimum ambient temperature and the minimum power battery temperature in the at least one time period comprises:
evaluating the minimum power battery temperature in the preset time period as the minimum power battery temperature in the first time period, when determining that the minimum ambient temperature in the first time period is lower than or equal to the minimum ambient temperature in the second time period, and the minimum power battery temperature in the first time period is lower than or equal to the minimum power battery temperature in the second time period; or
evaluating the minimum power battery temperature in the preset time period as the minimum power battery temperature in the second time period, when determining that the minimum ambient temperature in the first time period is lower than or equal to the minimum ambient temperature in the second time period, and the minimum power battery temperature in the first time period is higher than the minimum power battery temperature in the second time period.

4. The method according to claim 1, wherein the minimum ambient temperature and the minimum power battery temperature in the at least one time period comprises, a minimum ambient temperature and a minimum power battery temperature in a first time period and a minimum ambient temperature and a minimum power battery temperature in a second time period, the second time period is subsequent to the first time period, evaluating the minimum power battery temperature in the preset time period after the at least one time period according to the minimum ambient temperature and the minimum power battery temperature in the at least one time period comprises:
determining the minimum power battery temperature in the preset time period according to the minimum power battery temperature in the first time period, the minimum power battery temperature in the second time period and a second power battery temperature evaluation factor when determining that the minimum ambient temperature in the first time period is higher than the minimum ambient temperature in the second time period, and the minimum power battery temperature in the first time period is higher than the minimum power battery temperature in the second time period; or
determining the minimum power battery temperature in the preset time period according to the minimum power battery temperature in the first time period, a temperature constant and a third power battery temperature evaluation factor when determining that the minimum ambient temperature in the first time period is higher than the minimum ambient temperature in the second time period, and the minimum power battery temperature in the first time period is lower than or equal to the minimum power battery temperature in the second time period.

5. The method according to claim 1, wherein determining the minimum state-of-charge value that meets the start-up power requirement of the vehicle engine at the minimum power battery temperature in the preset time period comprises:
substituting the minimum power battery temperature in the preset time period into a discharge power Map of the power battery to obtain the minimum state-of-charge value of the power battery.

6. (canceled)

7. (canceled)

8. (canceled)

9. (canceled)

10. (canceled)

11. A vehicle, comprising:
a power battery controller for controlling a lower limit of a state-of-charge of a power battery, the power battery controller comprises: a detector, an evaluator and a processor, wherein;
the detector is configured to detect a minimum ambient temperature and a minimum power battery temperature in at least one time period;
the evaluator is configured to evaluate a minimum power battery temperature in a preset time period after the at least one time period according to the minimum ambient temperature and the minimum power battery temperature in the at least one time period;
the processor is configured to: determine a minimum state-of-charge value of the power battery that meets a start-up power requirement of a vehicle engine at the minimum power battery temperature in the preset time period, and adjust a lower limit value of the state-of-charge of the power battery according to the minimum state-of-charge value of the power battery.

12. A non-transitory computer readable storage medium which stores an instruction that is executed to cause a power battery controller of a vehicle to implement method for controlling a lower limit of a state-of-charge of a power battery, the method comprising:
detecting a minimum ambient temperature and a minimum power battery temperature in at least one time period;
evaluating a minimum power battery temperature in a preset time period after the at least one time period according to the minimum ambient temperature and the minimum power battery temperature in the at least one time period;
determining a minimum state-of-charge value of the power battery that meets a start-up power requirement of a vehicle engine at the minimum power battery temperature in the preset time period; and
adjusting a lower limit value of the state-of-charge of the power battery according to the minimum state-of-charge value of the power battery.

13. The vehicle according to claim 11, wherein the minimum ambient temperature and the minimum power battery temperature in the at least one time period only comprises a minimum ambient temperature and a minimum power battery temperature in a first time period, and the evaluator is further configured to:
determine the minimum power battery temperature in the preset time period according to the minimum power battery temperature, a temperature constant and a first power battery temperature evaluation factor in the first time period.

14. The vehicle according to claim 11, wherein the minimum ambient temperature and the minimum power battery temperature in the at least one time period comprise a minimum ambient temperature and a minimum power battery temperature in a first time period and a minimum ambient temperature and a minimum power battery temperature in a second time period, the second time period is subsequent to the first time period, and the evaluator is further configured to:
evaluate the minimum power battery temperature in the preset time period as the minimum power battery temperature in the first time period when determining that the minimum ambient temperature in the first time period is lower than or equal to the minimum ambient temperature in the second time period, and the minimum power battery temperature in the first time period is lower than or equal to the minimum power battery temperature in the second time period; or
evaluate the minimum power battery temperature in the preset time period as the minimum power battery temperature in the second time period when determining that the minimum ambient temperature in the first time period is lower than or equal to the minimum ambient temperature in the second time period, and the minimum power battery temperature in the first time period is higher than the minimum power battery temperature in the second time period.

15. The vehicle according to claim 11, wherein the minimum ambient temperature and the minimum power battery temperature in the at least one time period comprise a minimum ambient temperature and a minimum power battery temperature in a first time period and a minimum ambient temperature and a minimum power battery temperature in a second time period, the second time period is subsequent to the first time period, and the evaluator is further configured to:
determine the minimum power battery temperature in the preset time period according to the minimum power battery temperature in the first time period, the minimum power battery temperature in the second time period and a second power battery temperature evaluation factor when determining that the minimum ambient temperature in the first time period is higher than the minimum ambient temperature in the second time period, and the minimum power battery temperature in the first time period is higher than the minimum power battery temperature in the second time period; or
determine the minimum power battery temperature in the preset time period according to the minimum power battery temperature in the first time period, a temperature constant and a third power battery temperature evaluation factor when determining that the minimum ambient temperature in the first time period is higher than the minimum ambient temperature in the second time period, and the minimum power battery temperature in the first time period is lower than or equal to the minimum power battery temperature in the second time period.

16. The vehicle according to claim 11, wherein the processor is configured to: substitute the minimum power battery temperature in the preset time period into a discharge power Map of the power battery to obtain the minimum state-of-charge value of the power battery.
